(19) United States
(12) Patent Application Publication
(10) Pub. No.: US 2022/0126519 A1
(43) Pub. Date: Apr. 28, 2022

(54) 3D DIGITAL DESIGN POSES USING PHYSICAL MODELS

(71) Applicant: Hewlett-Packard Development Company, L.P., Spring, TX (US)

(72) Inventors: Ian N. Robinson, Palo Alto, CA (US); Ji Won Jun, Palo Alto, CA (US); Hiroshi Horii, Palo Alto, CA (US)

(73) Assignee: Hewlett-Packard Development Company, L.P., Spring, TX (US)

(21) Appl. No.: 17/431,287

(22) PCT Filed: Jul. 18, 2019
(86) PCT No.: PCT/US2019/042498

§ 371 Date: Aug. 16, 2021

(51) Int. Cl. B29C 64/393; G06T 7/73; G06T 17/00; B33Y 50/02

(52) U.S. Cl. CPC B29C 64/393; G06T 7/73; G06T 2200/08; B33Y 50/02; G06T 17/00

(57) ABSTRACT

A physical three-dimensional (3D) model is printed that corresponds to a 3D digital design of an underlying digital render model of an object. The physical 3D model includes markings associated with physically orientable parts. An image processing subsystem analyzes a captured image of the physical 3D model. A pose determination subsystem detects orientations of the physically orientable parts of the physical 3D model using the markings in the captured image. A rendering subsystem generates digitally posed renderings of the object with digitally orientable parts of the digital render model in orientations corresponding to the detected orientations of the physically orientable parts.

### BACKGROUND

Modern animation uses physical models as visual aids to create digital characters. For instance, animators may use a physical model to visualize characters in the physical world before creating a digital character. Viewing a physical model in the real world may allow the animator to study the model in its natural state.

### BRIEF DESCRIPTION OF THE DRAWINGS

Non-limiting and non-exhaustive examples of the disclosure are described, including various examples of the disclosure, with reference to the figures, in which:

FIG. 1 illustrates an example view of a system comprising a physical three-dimensional (3D) printed multipart object, a computing device, and a 3D digital design.

FIG. 2 illustrates an example view of a portion of a system comprising a 3D digital design for printing to a physical 3D-printed multipart object and a computing device.

FIG. 3 illustrates an example view of a 3D digital design comprising a connection between a first part and a second part, wherein the connection comprises a marking.

FIG. 4 illustrates an example block diagram of a computing system that includes a bus connecting controller, a memory, a communication interface, and a computer-readable storage medium.

FIG. 5 illustrates a flowchart of an example method for rendering a 3D digital design based on a physical 3D-printed multipart object.

### DETAILED DESCRIPTION

In computer-generated renderings, whether for still or animated output, a physical model of an object being rendered may be utilized by a user as a guide or reference, particularly when it comes to creating poses for that model. For example, wooden jointed mannequins are a reference tool for users dealing with humanoid figures. The physical model may allow the user to quickly manipulate the pose directly and view the result before attempting to adjust and render the subject on a computer or another digital device. Copying physical movements to a digital rendering may lead to human error and significant time spent visually comparing the animator-created digital image of the model with the physical model. Recreating a digital version of the physical model can be a difficult and time-consuming process.

Physical three-dimensional (3D) printed multipart objects, as described herein, provide enhanced functionality for rendering digital models. From the user's point of view, a 3D-printed model can more closely resemble the object being rendered and can thus serve as a more accurate reference. Physical 3D-printed multipart objects may be printed from a 3D digital design that is based on an underlying digital render model. In addition to the shape and texture of the object to be rendered, the 3D digital design may include physical joints that provide a range of motion analogous to the underlying digital render model that can be used to generate digitally posed renderings of the object in various poses. The 3D digital design may also include markings identifying the individual parts. For example, a part of a 3D digital design may include markings that identify two portions of an arm that can be moved into various orientations with respect to one another.

A user may pose a physical 3D-printed multipart object printed from the 3D digital design. A camera may capture an image of the physical 3D-printed multipart object and determine the pose based on the physical markings. The system may generate a digitally posed rendering of the object in the determined pose based on the underlying digital render model. The system may capture images and identify different poses as the parts of the physical 3D-printed multipart object are manipulated. Using information and constraints defined by the underlying 3D digital design, the system generates digitally posed renderings in poses corresponding to those captured in the images of the physical 3D-printed multipart object. The physical 3D-printed multipart object with markings decreases time and increases the accuracy and precision associated with generating digitally posed renderings of the 3D digital design.

The examples of this disclosure may be further understood by reference to the drawings, wherein like parts are designated by like numerals throughout. It will be readily understood that the components of the disclosed examples, as generally described and illustrated in the figures herein, could be arranged and designed in a wide variety of different configurations. Thus, the following detailed description of the examples of the systems and methods of the disclosure is not intended to limit the scope of the disclosure, as claimed, but is merely representative of possible examples of the disclosure. In addition, the steps of a method do not necessarily need to be executed in any specific order, or even sequentially, nor need the steps to be executed only once, unless otherwise specified.

In some cases, well-known features, structures, or operations are not shown or described in detail. Furthermore, the described features, structures, or operations may be combined in any suitable manner. It will also be readily understood that the components of the examples as generally described and illustrated in the figures herein could be arranged and designed in a wide variety of different configurations.

Several aspects of the examples described may be implemented as software modules or components. As used herein, a software module or component may include any type of computer instruction or computer-executable code located within a memory device and/or transmitted as electronic signals over a system bus or wired or wireless network. A software module or component may, for instance, comprise physical or logical blocks of computer instructions, which may be organized as a routine, program, object, component, data structure, etc., that performs tasks or implements particular abstract data types.

In certain examples, a particular software module or component may comprise disparate instructions stored in different locations of a memory device, which together implement the described functionality of the module. Indeed, a module or component may comprise a single instruction or many instructions and may be distributed over several different code segments, among different programs, and across several memory devices. Some examples may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Examples may be provided as a computer program product, including a non-transitory computer and/or machine-readable medium having stored thereon instructions that may be used to program a computer (or another electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of machine-readable media suitable for storing electronic and/or processor-executable instructions.

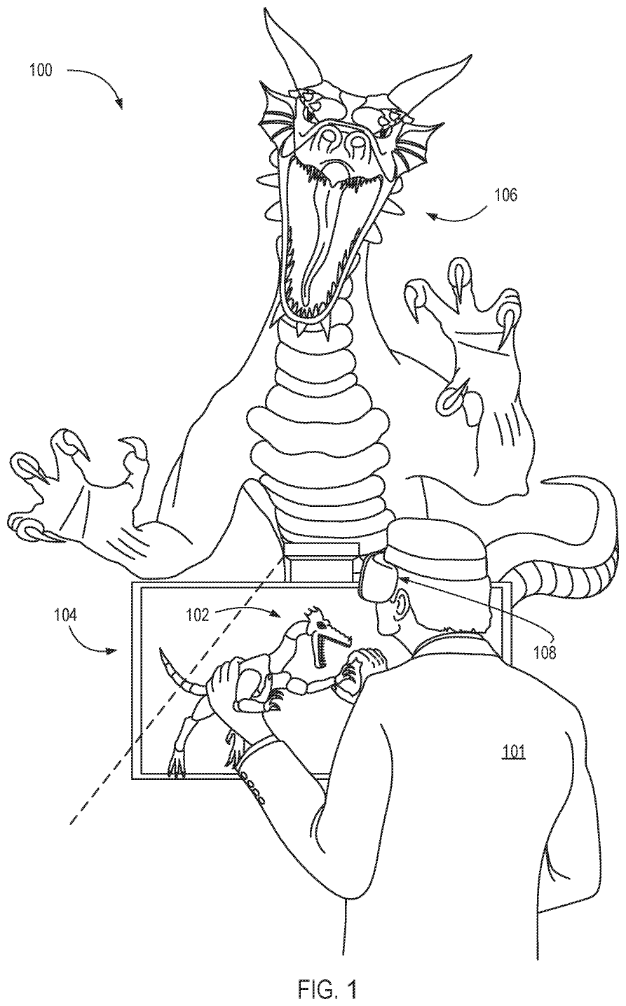

FIG. 1 illustrates an example view of a system 100 with a physical three-dimensional (3D) printed multipart object 102. The physical 3D-printed multipart object 102 may be printed with markings identifying orientable parts of the object based on a 3D digital design that includes corresponding digital markings. The 3D digital design used to print the object may be based on a digital render model of the object. As illustrated, a computing device 104 displays a digitally posed rendering of the object 106 in various poses as a user 101 manipulates the physical 3D-printed multipart object 102. In the illustrated example, the digitally posed rendering 106 is viewed life-size by the user 101 via an augmented reality (AR) and/or virtual reality (VR) headset 108. In other examples, digitally posed renderings may be viewed on an electronic display, such as a computer monitor or television, attached to the computing device 104.

As previously described, the physical 3D-printed multipart object 102 may comprise physical markings associated with physically orientable parts of the physical 3D-printed multipart object 102. In some examples, each part of the physical 3D-printed multipart object 102 may comprise a single marking. Each marking may identify a part, an orientation of the part, and/or a combination thereof. The physical 3D-printed multipart object 102 may be based on an underlying digitally rendered model of the object. Any number of digitally posed renderings 106 of the object may be generated as the physical 3D-printed multipart object 102 is manipulated (i.e., placed in different poses by re-orienting the physically orientable parts). In some examples, the user 101 may move the physical 3D-printed multipart object 102 into various poses to generate a set of different digitally posed renderings 106 for storage on the computing device 104. In some examples, the digitally posed rendering 106 may be generated by a display subsystem.

A 3D printer may print the physical 3D-printed multipart object 102 based on the 3D digital design. The underlying digitally rendered design may have significantly more detail than the physical 3D-printed multipart object 102. Accordingly, manipulation of a relatively low-detail physical 3D-printed multipart object 102 may result in relatively high-detail digitally posed renderings 106 of the object for display.

The physical 3D-printed multipart object 102 may comprise markings corresponding to those on the 3D digital design. For example, the 3D digital design associated with the illustrated dragon may include markings on the upper and lower portions of the right and left arms. The physical 3D-printed multipart object 102 is printed to include corresponding markings on the upper and lower portion of the right and left arms. For example, the 3D digital design may include digital markings that are a part of the object to be printed. Thus, when the 3D digital design is printed, the resulting physical 3D-printed multipart object has physical markings that are in the locations specified by the 3D digital design. The markings do not need to be manually added, positioned or aligned since they are specified by the 3D digital design.

As described herein, each orientable part of the physical 3D-printed multipart object 102 may comprise a single physical marking or multiple physical markings. The markings may be automatically added by the computer system based on the location of joints separated distinct, orientable parts of the object. In some examples, a user may specific joint locations and/or orientable parts of the object and add markings to the 3D digital design to become a part of the subsequently created physical 3D-printed multipart object 102. In some example, the user may specify joint locations and/or orientable parts of the object when created the digital render model. The system may generate the 3D digital design to include markings associated with each of the user-specified joint locations and/or orientable parts of the object. A 3D printer may be used to print the 3D digital design with physical markings specified by the 3D digital design, which are in turn based on the user-specified joints and/or orientable parts of the user-created digital render model. Accordingly, the user is able to generate a physical object from a digital model and map captured movement back to the digital model with minimal effort on the part of the user.

In various example, each marking may be, for example, a color, a QR code, a line, steganographic information, another form of identification, and/or a combination thereof. The user may change the orientation of the orientable part(s) of the physical 3D-printed multipart object 102 through physical manipulation.

In some examples, a pose determination subsystem detects orientations of the orientable parts by comparing the relative location of the physical markings. For example, the physical 3D-printed multipart object 102 may resemble a dragon. A user may pose the tail of the dragon starting with the tail on the left and ending with the tail on the right. The markings on the tail may identify the orientable part as the tail. The change in orientation of the tail and/or an amount of change in the tail may be determined by determining the change in position and orientation of the markings on the tail with respect to the position and orientation of markings on the body to which the tail is attached. The relative position and orientation of the two markings may allow the system to detect the orientation of the two parts and/or the joint between the two parts.

To detect the changes in orientation of the physical 3D-printed multipart object 102, the system may use a camera to capture an image of the physical 3D-printed multipart object 102. In some examples, the camera may be a part of an image processing subsystem, the computing device 104, another part of the system, and/or a combination thereof. The image processing subsystem may analyze the captured image of the physical 3D-printed multipart object 102. The image processing subsystem may identify the markings on the 3D-printed part in the image. In some examples, the image processing subsystem may detect which 3D digital design corresponds to the physical 3D-printed multipart object 102. For instance, the physical 3D-printed multipart object 102 may include physical markings that identify each orientable part and an additional marking or markings that enable the system to determine to which 3D digital design the physical 3D-printed multipart object 102 corresponds (e.g., from a database of multiple 3D digital designs). In some examples, the system may utilize data associated with a marking to compare the marking of the 3D digital design to the marking of the physical 3D-printed multipart object 102.

The pose determination subsystem may utilize the identified markings, the 3D digital design, and/or the underlying digital render model to detect orientations of the physically orientable parts of the physical 3D-printed multipart object 102. For example, a tree may have a marking on a first branch and a second branch. The orientation of the first branch may be changed. The pose determination subsystem may detect a change between the marking on the first branch and the marking on the second branch. The change in relative position between the markings may allow the pose determination subsystem to detect a relative change in orientation of the first branch.

A display subsystem may render a digitally posed rendering of the object for display on an electronic display in a pose corresponding to the pose of the physical 3D-printed multipart object 102. The pose determination subsystem may review each part of the physical 3D-printed multipart object 102 to detect the parts that have a change in orientation and the parts that have no change in orientation.

As another example, a 3D-printed multipart object resembling a cat may be printed based on a 3D digital design. The 3D digital design includes digital markings that identify articulation points of the cat (i.e., parts of the cat that can be re-oriented relative to other parts of the cat). A 3D digital design of the cat can be printed by a 3D printer and is based on a digital render model of the cat that captures the render model's articulation capabilities.

The system can utilize captured images of the physical 3D-printed cat in different poses and generate digitally posed renderings of the cat in corresponding poses. In some examples, digital markings may identify positions of orientable parts of the cat. Each combination of different orientations of the orientable parts of the 3D digital design of the cat correspond to a unique pose of the cat.

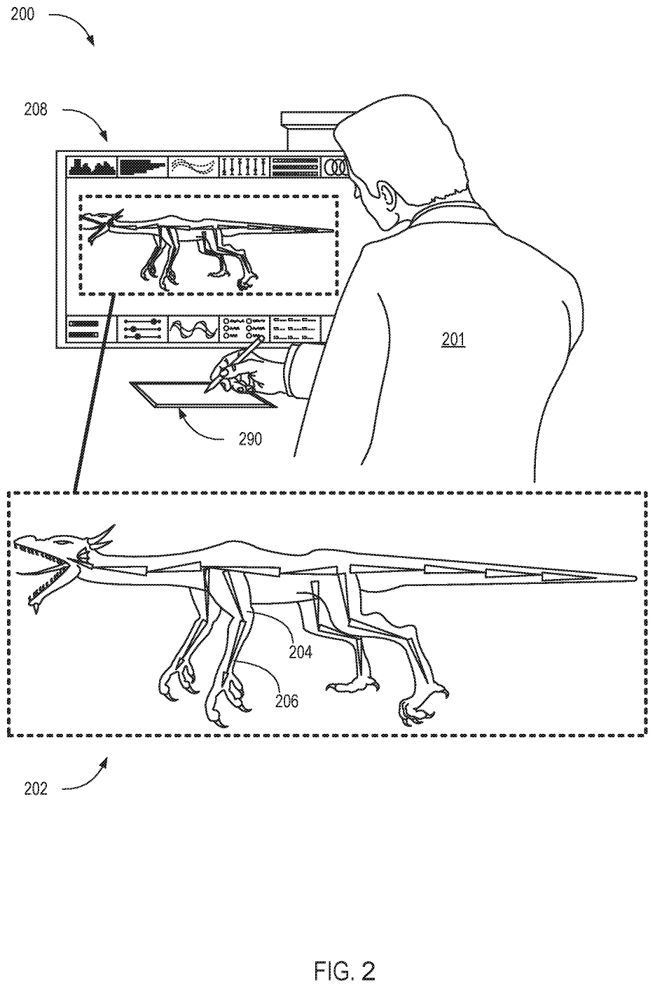

FIG. 2 illustrates an example view of a portion of a system 200 in which a creator 201 has created a digital render model of a dragon via an input device 290. The creator 201 may provide or edit a skeleton or bone hierarchy of the dragon, as illustrated by the triangles 204 and 206. The skeleton or bone hierarchy enables a digital render model 202 to be positioned in various poses. A computing device 208 may use the skeleton or bone hierarchy to generate a 3D digital design with separate parts corresponding to each bone connected by, for example, a hinge and/or ball joint. The 3D digital design based on the digital render model 202 can be used to print a physical 3D-printed multipart object. The physical 3D-printed multipart object is printed to include markings identifying the orientable parts (e.g., each jointed part) of the digital render model created by the creator 201. In some examples, the system may automatically determine the location of joints and add corresponding markings without requiring user interaction. In such examples, the system may process the user-created digital render model 201 to identify orientable parts of the object (e.g., those connected by joints) and generate a 3D digital design that includes corresponding markings. Once printed, the physical 3D-printed multipart object will include physical markings as specified by the 3D digital design.

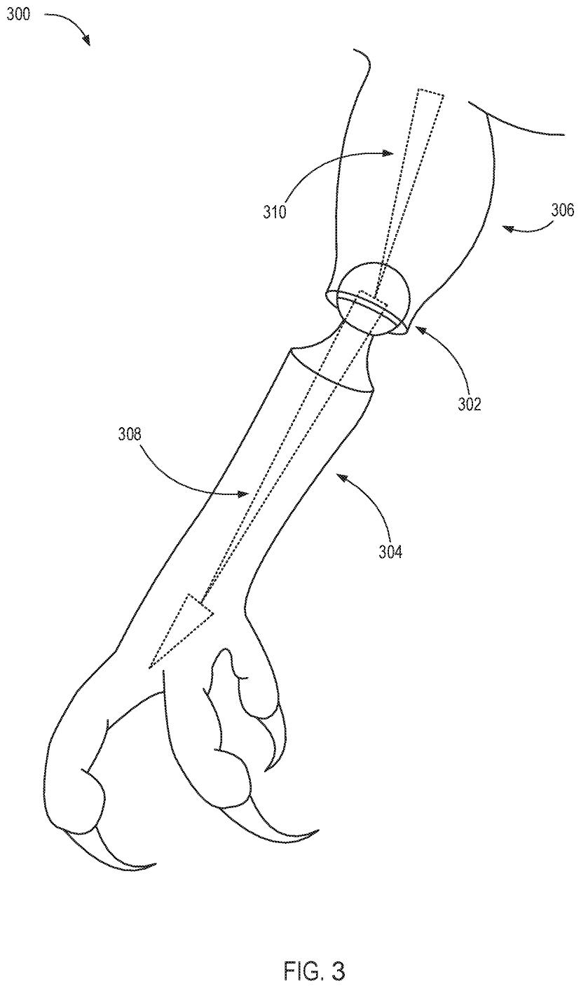

FIG. 3 illustrates an example view of a portion of a 3D digital design of an object 300 (an arm in the illustrated example) that includes a ball-joint connection 302 between a first part 304 and a second part 306. The ball-joint connection 302 in the 3D digital design of the object 300 corresponds to the connection between a first bone 308 in the underlying digital render model and a second bone 310 in the underlying digital render model. The system may create the 3D digital design of the object 300 based on the underlying digital render model to include joints connected to each orientable part of the digital render model (e.g., based on bone placement). The system may also add markings to the 3D digital design that will be visible once the 3D digital design is printed. The markings enable the system to identify each distinct part of the object and associated orientation in subsequently captured images. The markings may include, for example, lines, QR codes, colors, images etc.

Once the 3D digital design is printed as a physical 3D-printed multipart object, a user may change the orientation of a part or parts of the printed physical 3D-printed multipart object to select a pose of the object. The system captures an image of the physical 3D-printed multipart object in the selected pose. The system uses the markings on the 3D-printed multipart object to identify the pose (i.e., the orientation of the various orientable parts). For example, an image processing subsystem may analyze the captured image of the physical 3D-printed multipart object. The image processing subsystem may detect the markings on the physical 3D-printed multipart object. A pose determination subsystem may detect orientations of the physically orientable parts of the physical 3D-printed multipart object based on the relative locations of the physical markings in the captured image. For example, the arm illustrated in FIG. 3 may be printed in the position shown, with the arm pointing toward the ground. The user may change the orientation of the arm such that the lower, first part 304 of the arm points upwards. A marking may identify the first part 304 as the lower portion of an arm and another marking may identify the second part 306 as an upper portion of an arm. In some examples, the system uses a relative position (e.g., an angle and/or a distance) of the markings on parts 304 and 306 to determine the orientation of the first part 304. The display subsystem may generate a digitally posed rendering of the object 300 in a pose corresponding to that of the captured image of the physical 3D-printed multipart object by adjusting the digital render model's bones 308 and 310 to correspond to the identified orientations of the corresponding first 304 and second 306 parts of the physical 3D-printed multipart object. The display subsystem may render the digitally posed rendering of the object 300 for display on an electronic display. The system may also capture and store a sequence of digitally posed renderings of the object 300 as the 3D-printed multipart object is manipulated through a sequence of poses. Such a sequence of digitally posed renderings may be useful for animation of the object.

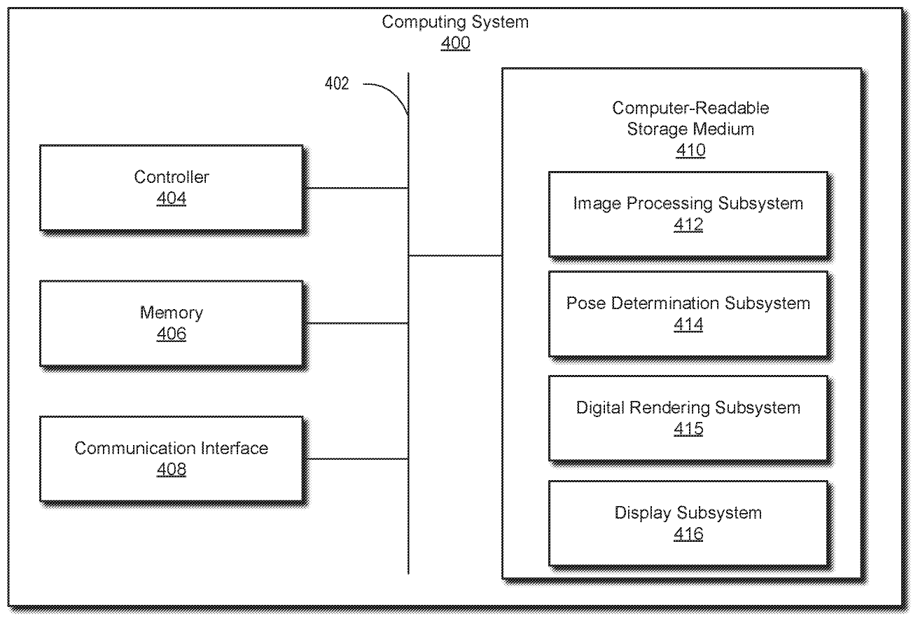

FIG. 4 illustrates an example block diagram of a computing system 400 that includes a bus 402 connecting a controller 404 (e.g., microprocessor, field programmable gate array (FPGA), microcontroller, etc.), a memory 406, a communication interface 408, and a computer-readable storage medium 410. The computer-readable storage medium 410 may include various subsystems 412-416. In the illustrated example, the subsystems 412-416 are implemented as instructions to be executed by the controller 404. However, in other examples, the subsystems 412-416 may be implemented as processor-executable instructions, firmware, hardware, electronic components, and/or combinations thereof.

An image processing subsystem 412 may analyze a captured image of a physical 3D-printed multipart object that includes physical markings associated with physically orientable parts of the physical 3D-printed multipart object. As described herein, the physical 3D-printed multipart object corresponds to a 3D digital design of the multipart object. The 3D digital design of the multipart object may be based on an underlying digital render model and include various markings associated with orientable parts of the object. The image processing subsystem 412 may capture an image or receive a captured image. In some examples, the image processing subsystem 412 may store the captured image. For example, an image may be captured of a physical 3D-printed multipart object resembling a cat. The captured image of the cat may be utilized to generate a digitally posed rendering of the cat.

A pose determination subsystem 414 may analyze images captured by the image processing subsystem 412 to detect orientations of the physically orientable parts of the physical 3D-printed multipart object based on the relative locations of the physical markings in the captured image. In some examples, the pose determination subsystem 414 detects orientations of the orientable parts of the 3D-printed multipart object by comparing the relative location of the physical markings. In some examples, the pose determination subsystem 414 stores the captured image.

The pose determination subsystem 414 may determine the orientation of each part based on the distance and/or an angle between a first marking and a second marking. In some examples, one of the plurality of markings identifies a first part of the physical 3D model and an orientation of a first part relative to a second part. For example, the system may identify an orientation of a lower portion of an arm relative to an upper portion of an arm.

A digital rendering subsystem 415 generates a digitally posed rendering of the object in a pose corresponding to the pose captured in the image of the 3D-printed multipart object. The display subsystem 416 may render the digitally posed rendering of the object for display on an electronic display or AR/VR headset.

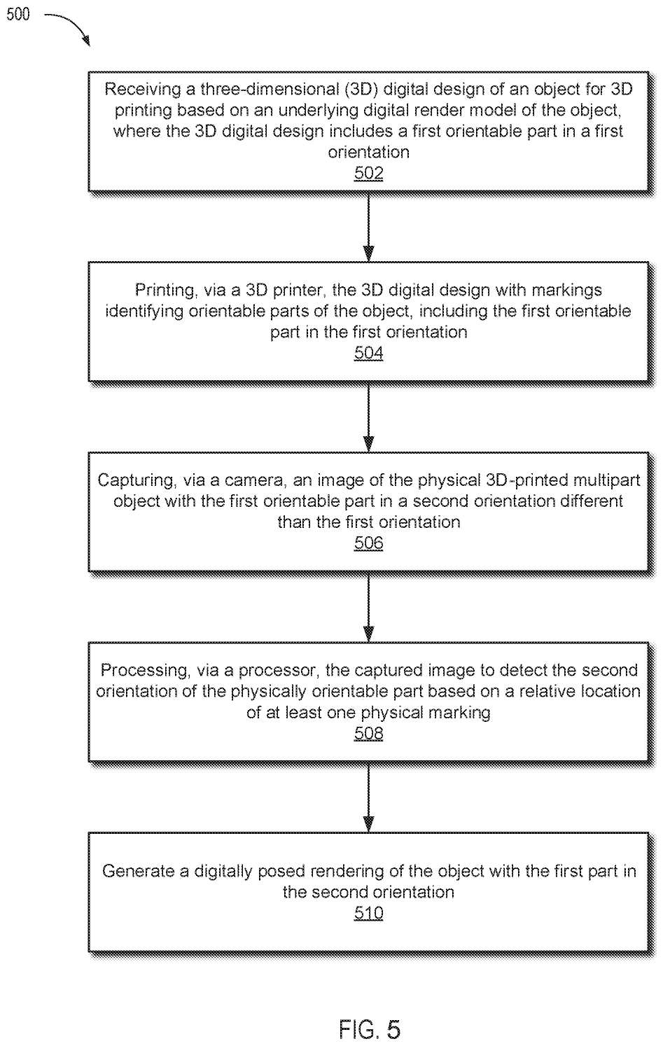

FIG. 5 illustrates a flowchart of an example method 500 for generating a digitally posed rendering of an object based on a posed physical 3D-printed multipart object. The system receives, at 502, a 3D digital design that can be 3D-printed. The 3D digital design may be based on an underlying digital render model and include markings that identify orientable parts of the object. A 3D printer prints, at 504, a physical multipart object based on the 3D digital design. The physical 3D-printed multipart object includes physical markings associated with physically orientable parts corresponding to the digitally orientable parts of the underlying digital render model. As described herein, markings may identify each part and/or each part's orientation relative to other parts. The 3D digital design may include a first orientable part in a first orientation.

A camera may capture, at 506, an image of the physical 3D-printed multipart object with the first orientable part in a second orientation different than the first orientation. The system may process, at 508, the captured image to detect the second orientation of the first orientable part using the physical markings. The system may generate, at 510, a digitally posed rendering of the object with the first part in the second orientation.

While specific examples and applications of the disclosure have been illustrated and described, it is to be understood that the disclosure is not limited to the precise configurations and components disclosed herein. Accordingly, many changes may be made to the details of the above-described examples without departing from the underlying principles of this disclosure. The scope of the present invention should, therefore, be determined only by the following claims.

What is claimed is:

1. A system, comprising:
an image processing subsystem to analyze a captured image of a physical three-dimensionally-printed (3D-printed) multipart object that includes physical markings associated with physically orientable parts of the physical 3D-printed multipart object, wherein the physical 3D-printed multipart object corresponds to a 3D digital design of the multipart object;
a pose determination subsystem to detect orientations of the physically orientable parts of the physical 3D-printed multipart object based on the relative locations of the physical markings in the captured image; and
a rendering subsystem to render, for display on an electronic display, a digitally posed rendering of the multipart object with digitally orientable parts in orientations corresponding to the detected orientations of the physically orientable parts.

2. The system of claim 1, wherein the 3D digital design of the multipart object is based on an underlying digital render model of the object, and wherein the digitally posed rendering comprises a rendering of the underlying digital render model with the digitally orientable parts in orientations corresponding to the detected orientations of the physically orientable parts.

3. The system of claim 1, wherein the 3D digital design of the multipart object is based on a high-detail digital render model and the physical 3D-printed multipart object comprises a relatively low-detail 3D-printed version of the 3D digital design.

4. The system of claim 1, wherein locations of the physical markings correspond to orientable parts of the 3D digital design of the multipart object that are connected by joints.

5. The system of claim 1, wherein the pose determination subsystem detects orientations of the orientable parts of the 3D-printed multipart object by comparing the relative locations of the physical markings.

6. The system of claim 1, wherein one of the physical markings comprises an identifying color.

7. The system of claim 1, wherein one of the physical markings comprises a line.

8. The system of claim 1, wherein one of the physical markings comprises a QR code.

9. A non-transitory computer-readable medium with instructions stored thereon that, when implemented by a processor, cause the processor to perform operations for rendering a digital render model of an object in a pose corresponding to that of a physical 3D model of the object, the operations comprising:
generating a 3D digital design of the digital render model of the object that can be printed by a 3D printer;
printing, via a 3D printer, a physical 3D model corresponding to the 3D digital design, wherein the physical 3D model is printed to include markings that identify orientable portions of the physical 3D model that correspond to orientable portions of the digital render model of the object;
capturing, via a camera, an image of the physical 3D model;
analyzing the captured image to detect a first pose of the physical 3D model based on detected markings indicating orientations of the orientable portions of the physical 3D model; and
generating a digitally posed rendering of the object in the detected first pose of the physical 3D model.

10. The non-transitory computer-readable medium of claim 9, wherein one of the plurality of markings identifies a first portion of the physical 3D model and an orientation of the first portion relative to a second portion of the physical 3D model.

11. The non-transitory computer-readable medium of claim 9, wherein one of the markings is an image.

12. The non-transitory computer-readable medium of claim 9, wherein the operations further comprise identifying locations for printing the markings on the physical 3D model based on locations of joints in the 3D digital design.

13. A method comprising:
identifying a three-dimensional (3D) digital design of a digital render model of an object that includes a digitally orientable part in a first orientation;
printing, via a 3D printer, a physical model of the 3D digital design, wherein the physical model comprises a physical marking associated with a physically orientable part corresponding to the digitally orientable part;
capturing, via a camera, an image of the physical model with the physically orientable part in a second orientation different than the first orientation of the corresponding digitally orientable part;
processing, via a processor, the captured image to detect the second orientation of the physically orientable part based on a relative location of the physical markings; and
rendering a digital render model of the object with the digitally orientable part of the 3D digital design in the second orientation.

14. The method of claim 13, wherein the printed physical model has less detail than the 3D digital design from which it was printed.

15. The method of claim 13, wherein the 3D digital design comprises one digital marking corresponding to each physical marking on the physical model.
